(19) United States
(12) Patent Application Publication
(10) Pub. No.: US 2011/0120676 A1
(43) Pub. Date: May 26, 2011

(54) Cool Ride

(76) Inventors: Roscoe J. Chandler, Midlothian, TX (US); Joseph R. Chandler, Fort Worth, TX (US)

(21) Appl. No.: 12/626,389

(22) Filed: Nov. 25, 2009

Related U.S. Application Data
(60) Provisional application No. 61/186,866.

(51) Int. Cl. F28D 15/00

(52) U.S. Cl. 165/104.31

(57) ABSTRACT

The present invention may include a cooling system for the user which may include a spray dispenser for dispensing fluid spray on the user, a steering handle or other available mounting surface to mount the spray dispenser, a fluid reservoir to store the fluid, and a fluid pump to pump the fluid from the fluid reservoir to the spray dispenser. The steering handle may be a steering handle for a motorcycle, and the fluid may be water. The fluid pump may be connected to a energy source, and the energy source may be a battery. The energy source may be a alternator and the spray dispenser may include a elongated tube, and the spray dispenser may include an aperture. The spray dispenser may be detachably connected to the steering handle and the fluid pump may be operated by a switch. The switch may be mounted on the steering handle or other available mounting surface.

### PRIORITY

The present invention claims priority under 35 USC section 119 and based upon a provisional application 61/186,866 which was filed on Jun. 14, 2009.

### FIELD OF THE INVENTION

The present invention relates to cooling systems and more particularly to a cooling system to be used with a motorcycle or vehicles that the operator is exposed to the elements.

### BACKGROUND

Motorcycles are being purchased and enjoyed in ever-increasing numbers. As energy prices increase, alternative methods of transportation which consume less energy are increasingly desirable. Motorcycles offer both simple transportation and recreation for the user. Even large motorcycles can be more fuel-efficient than small economy cars.

Two- and three-wheeled motorcycles, motor scooters, and snowmobiles have handlebars for steering purposes. In such motor vehicles, switches for controlling various electric components, such for example as a dimmer switch for headlights, a switch for a horn, a switch for blinkers or turn signal lamps, and a starter switch for starting a self-starter, are fixed to the handlebar near the grips thereof so that they can easily be operated by the driver's thumbs while the handlebars are being gripped by the driver's hands.

### SUMMARY

The present invention may include a cooling system for the user which may include a spray dispenser for dispensing fluid spray on the user, a steering handle to mount the spray dispenser, a fluid reservoir to store the fluid, and a fluid pump to pump the fluid from the fluid reservoir to the spray dispenser.

The steering handle may be a steering handle for a motorcycle, and the fluid may be water.

The fluid pump may be connected to a energy source, and the energy source may be a battery.

The energy source may be a alternator and the spray dispenser may include a elongated tube, and the spray dispenser may include an aperture.

The spray dispenser may be detachably connected to the steering handle and the fluid pump may be operated by a switch.

The switch may be mounted on the steering handle.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a system diagram of the cooling system of the present invention;

FIG. 2 illustrates a cross-sectional view of the spray dispenser of the present invention;

FIG. 3 illustrates the cooling system being positioned on a motorcycle;

FIG. 4 illustrates the cooling system being positioned on a steering wheel.

### DETAILED DESCRIPTION

Typically, the user of a motorcycle is cooled by the flow of air while the motorcycle is being ridden. However, in some climates, the summers are extremely warm and the flow of air achieved by the motorcycle is insufficient in order to achieve sufficient cooling for the user of the motorcycle. Furthermore, the need for additional or supplemental cooling may not be apparent until after the motorcycle has been purchased. Additionally, removal of the cooling system during seasons when hot weather is not prevalent may be desirable.

There is a need for a supplemental cooling system that can be used in conjunction with a motorcycle, a motor scooter, bicycle, an all-terrain vehicle, jeeps, convertible automobiles, military vehicles, tractors, recreational boats, motocross bikes or any vehicle that the operator is exposed to the elements. Furthermore, the cooling system may be detachably connected to the vehicle, more particularly detachably connected to the steering handle of the vehicle or other available mounting surfaces. The cooling system may include a spray dispenser which generates and dispenses a fine spray and may be positioned so that the fine spray is received by the driver/user or the passenger of the vehicle. When the fine spray reaches the user which may be either the driver or passenger of the vehicle, and an evaporative cooling effect may be achieved on and around the skin of the user to eliminate the effects of the weather. The cooling system may include a user activated switch in order to control the cooling system and may prevent overheating and discomfort. The fine spray may be generated from a fluid such as water or other appropriate fluid. The cooling system may include a filter device to filter the fluid and the fluid may be stored in a fluid reservoir which may be detachably connected to the vehicle. The fluid reservoir may include a detachable cap in order that the fluid may be replaced. The fluid reservoir may be connected to the spray dispenser by a flexible tube.

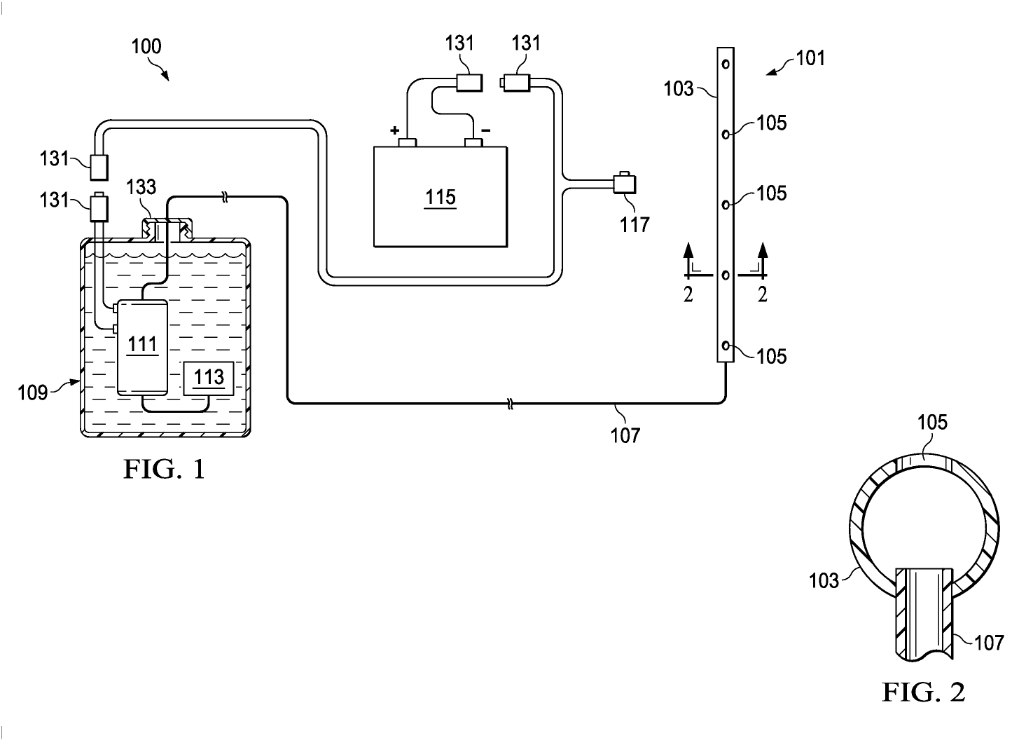

FIG. 1 illustrates a cooling system 100 of the present invention which may be used in conjunction with a motorcycle, a motor scooter, bicycle, an all-terrain vehicle, jeeps, convertible automobiles, military vehicles, tractors, recreational boats, motocross bikes or any vehicle. The cooling system 100 may include a spray dispenser 101 which may be detachably connected to a steering handlebar or a steering wheel or other device which may be located upwind of the user of the vehicle. The spray dispenser 101 may include an elongated tube 103 which may be a cylinder, rectangle or other shape tube and may be hollow in order to distribute the fluid through the apertures 105. The spray dispenser 101 may include a plurality of apertures 105 or other mist generating devices which may be longitudinally aligned along the elongated tube 103 or individually positioned. The spray dispenser 101 may include a single aperture 105. The spray dispenser 101 may be connected to a connecting tubing 107 or hose which may be flexible tubing or rigid tubing, and the connecting tubing 107 may supply the spray dispenser 101 with a fluid which may be water. The fluid flows through the hollow area of the elongated tube 103 or to each misting aperture and may flow under pressure to the aperture 105 and as a result of the size of the aperture 105 a fine mist may be generated. The mist may exit the aperture 105 and flow to the user of the vehicle. FIG. 1 additionally illustrates a fluid reservoir 109 which may be connected to the other end of the connecting tube 107 and may be remotely connected to the vehicle. The fluid reservoir 109 may be hollow but fluid tight and may house internally a fluid pump 111 and may be connected to the connecting tube 107 to provide pressurized fluid to the connecting tube 107 and the spray dispenser 101. The fluid reservoir 109 may house internally or externally a filter device 113 to filter fluid as the fluid is input to the filler device 113 which may be connected to the fluid pump 111 to pump the fluid from the filter device 113 to the connecting tube 107 and the spray dispenser 101. The present invention may satisfactory operate with unfiltered fluid and consequently the filter 113 may be omitted in some cooling systems. The fluid reservoir 109 may include a detachable cap 133 in order to replenish any fluid which may have been used or evaporated. The detachable cap 131 may include internal threads to cooperate with external threads on the fluid reservoir 109 so that the detachable 131 can be replaced after being removed.

The fluid pump 111 may be an electrical device or may be a mechanical device and may be connected to a energy source 115 which may be a battery, or may be directly connected to the alternator of the vehicle. A control switch 117 may be connected to the energy source 115 and may be physically positioned at a convenient place on the vehicle for the operator of the vehicle. The control switch 117 may be connected to the fluid pump 111 and may activate and deactivate the fluid pump 111 in order to activate the generation of mist from the spray dispenser 101 or to deactivate the generation of mist from the spray dispenser 101. The connection of the switch 117 to the energy source 115 and the fluid pump 111 may be by wires and may include connectors 131 in order to isolate the energy source 115 and the fluid pump 111.

FIG. 2 illustrates a cross section of the spray dispenser 101 and the elongated tube 103 and illustrates the aperture 105.

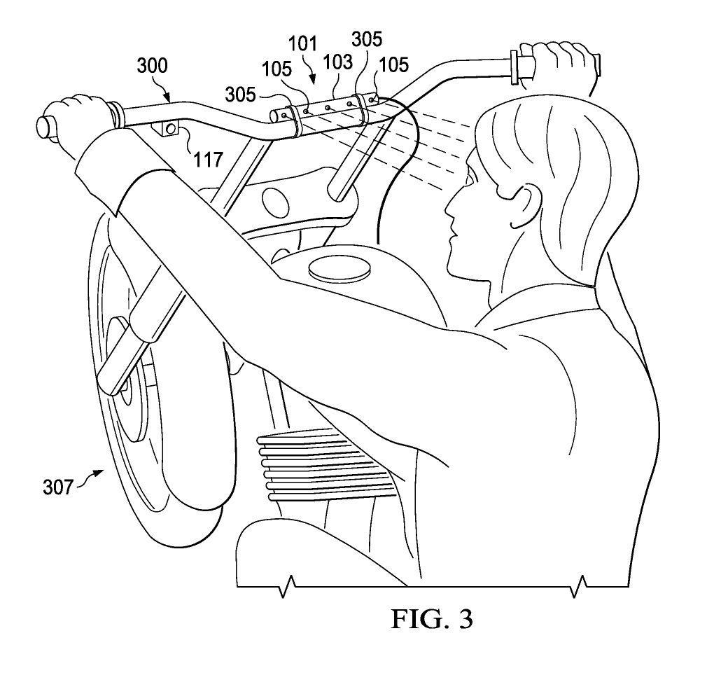

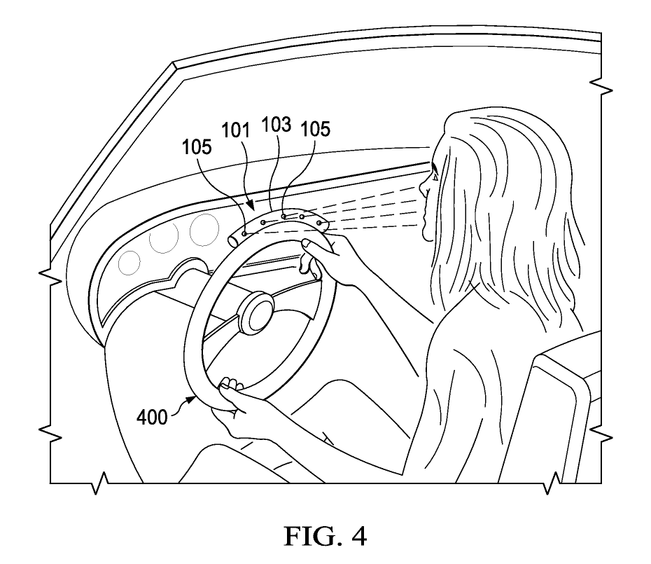

FIG. 3 illustrates a perspective view of a steering handle 300 of the motorcycle 307 and illustrates the spray dispenser 100 detachably mounted on the steering handle 300 with clamps 305 and illustrates the elongated tube 103 and apertures 105. FIG. 3 illustrates the control switch 117.

FIG. 4 illustrates a perspective view of a steering wheel 400 and illustrates the spray dispenser 100 mounted on the steering wheel 400.

The steering wheel 400 or the steering handle 300 may be mounted on a motorcycle, a motor scooter, bicycle, an all-terrain vehicle, jeeps, convertible automobiles, military vehicles, tractors, recreational boats, motocross bikes or any vehicle that the operator is exposed to the elements.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A cooling system for the user, comprising:
a spray dispenser for dispensing fluid spray on the user.
a steering handle to mount the spray dispenser;
a fluid reservoir to store the fluid;
a fluid pump to pump the fluid from the fluid reservoir to the spray dispenser.

2) A cooling system for the user as in claim 1, wherein the steering handle is a steering handle for a motorcycle.

3) A cooling system for the user as in claim 1, wherein the fluid is water.

4) A cooling system for the user as in claim 1, wherein the fluid pump is connected to a energy source.

5) A cooling system for the user as in claim 4, wherein the energy source is a battery.

6) A cooling system for the user as in claim 4, wherein the energy source is a alternator.

7) A cooling system for the user as in claim 1, wherein the spray dispenser includes a elongated tube.

8) A cooling system for the user as in claim 1, wherein the spray dispenser includes aperture.

9) A cooling system for the user as in claim 1, wherein the spray piece dispenser is detachably connected to the steering handle.

10) A cooling system for the user as in claim 1, wherein the fluid pump is operated by a switch.

11) A cooling system for the user as in claim 10, wherein the switch is mounted on the steering handle.

12) A cooling system for the user as in claim 1, wherein the spray dispenser is mounted on another mounting surface.

13) A cooling system for user as in claim 1, wherein the spray dispenser includes a individual spray aperture.
